(19) United States
(12) Patent Application Publication
(10) Pub. No.: US 2023/0031428 A1
(43) Pub. Date: Feb. 2, 2023

(54) HEIGHT MILLING DEVICE AND HEIGHT MILLING COMPONENT THEREOF

(71) Applicant: VERO VERIA CORPORATION, New Taipei City (TW)

(72) Inventor: Chien-Teh Huang, New Taipei City (TW)

(21) Appl. No.: 17/543,847

(22) Filed: Dec. 7, 2021

(30) Foreign Application Priority Data
Jul. 27, 2021 (TW) 110127452
Jul. 27, 2021 (TW) 110208795

(51) Int. Cl. B23C 3/12; B23C 5/10

(52) U.S. Cl. CPC B23C 3/12; B23C 5/10; B23P 23/04

(57) ABSTRACT

A height milling device is provided, which has a base platform with a working surface and at least a height milling component displaceably disposed on the working surface for performing a height machining on a target object, thereby speeding up the production, improving the production efficiency and reducing the labor cost.

### BACKGROUND

### 1. Technical Field

The present disclosure relates to burr machining machine tools, and more particularly, to a height milling device and a height milling component thereof.

### 2. Description of Related Art

Nowadays, elevated floor devices are widely applied in anti-static machine rooms or clean rooms. To prepare elevated floors by die casting of aluminum alloy, five main machinings need to be performed, which include mold-making, aluminum melting, die casting, molding and trimming. However, during the molding machining, many burrs occur on the surface and bottom of the elevated floors, which not only adversely affect tight attachment between the elevated floors and between the elevated floors and a platform frame, but also are not conducive to installation and bring some safety concerns for workers.

Conventionally, after the molding machining, the burrs on four foot bases of the elevated floor must be removed manually, which results in a low production efficiency and is both time and labor consuming.

Therefore, how to overcome the above-described drawbacks of the prior art has become an urgent issue in the art.

### SUMMARY

In view of the above-described drawbacks, the present disclosure provides a height milling component, which comprises: at least one milling tool; at least one motor integrated with the milling tool in a linear manner for directly driving the milling tool; at least one support structure having sliding rails disposed on surfaces of two opposite sides thereof; at least one carrying structure symmetrically disposed on left and right sides of the support structure, wherein the motor and the milling tool are disposed on one side of the carrying structure and a sliding base is disposed on another side of the carrying structure; and at least one adjustment structure for driving the milling tool on the carrying structure to move linearly up and down along the sliding rails to reach a height required to machine foot bases.

In an embodiment, the carrying structure is an L-shaped frame body symmetrically disposed on the left and right sides of the support structure, and the motor and the milling tool are disposed on said one side of the carrying structure in a manner that the milling tool on the carrying structure moves linearly up and down along the sliding rails.

The present disclosure further provides a height milling device, which comprises: the above-described height milling component; a base platform having a working surface; a positioning structure disposed on and in parallel to the working surface for carrying a target object and limiting displacement of the target object, wherein the target object has opposite first and second surfaces, a side surface adjacent to and connecting the first and second surfaces, and a flange protruding from the side surface, and four corners of the second surface have four foot bases; a fastening portion disposed at two opposite sides of the positioning structure for fastening the target object on the positioning structure; and a driving structure for driving the support structure to displace and drive the height milling component to move linearly to perform a height milling machining on the target object.

In an embodiment, the height milling component is displaceably disposed on the working surface of the base platform and arranged at the two opposite sides of the positioning structure to perform the height milling machining on the target object and machine end surfaces of the foot bases of the target object, wherein the at least one motor and the milling tool are disposed on the support structure of the base platform via the carrying structure, wherein the motor and the milling tool are disposed on the same side of the carrying structure, and wherein the positioning structure has a stop portion disposed on an outer side thereof for blocking the side surface of the target object.

In another embodiment, the driving structure comprises a ball screw, a bearing engaged with the ball screw and disposed on a bearing base fastened on the base platform, and a nut engaged with the ball screw and fastened on a bottom of the support structure.

Moreover, the height milling device further comprises a power unit fixedly disposed on the base platform via a reducer and used for driving the reducer to rotate the ball screw.

In an embodiment, the height milling device further comprises a plurality of sliding blocks disposed on a bottom of the support structure and a plurality of sliding rails disposed on the base platform and correspondingly engaged with the sliding blocks to enable the sliding blocks to move linearly along the sliding rails, thereby causing the driving structure to simultaneously drive the support structure, the two carrying structures on the support structure, and the motor and the milling tool fastened on the carrying structure to displace a certain distance relative to the base platform.

In an embodiment, the height milling device further comprises a guiding structure having a sliding rail fastened on the support structure and a sliding base fastened on the carrying structure and engaged with the sliding rail to enable the carrying structure to be disposed on the support structure via the guiding structure, thereby driving the carrying structure and the milling tool thereon to rise and descend relative to the support structure when the adjustment structure actuates.

In an embodiment, the adjustment structure comprises a rotating rod and a rotating disc rotated by the rotating rod, and the adjustment structure rotates a reducer to drive a screw to rotate, thereby driving a nut fastened on the carrying structure to move up and down, driving the carrying structure to rise and descend, and moving the milling tool to a required height position.

In an embodiment, the support structure has a baffle disposed thereon and the base platform has a limiter abutting against the baffle for controlling a position of the baffle, thereby controlling a displacement of the support structure.

In an embodiment, the two separate support structures and the four separate carrying structures are provided to form two units each comprising the one support structure and the two carrying structures, the two units are parallelly disposed at the two opposite sides of the positioning structure, respectively, and the two separate carrying structures of each unit are fastened on the two opposite sides of the corresponding support structure, respectively, such that the milling tools on the carrying structures are simultaneously driven by the same power unit.

According to the present disclosure, by actuating the milling tool via the servo motor (e.g., the servo motor may be used as a motor), the height milling component can perform a height machining on foot bases of such as an elevated floor, thus speeding up the production, improving the production efficiency and reducing the labor cost.

### BRIEF DESCRIPTION OF DRAWINGS

FIG. 1A-1 is a schematic front perspective view of a height milling device applied to a machining apparatus according to the present disclosure.

FIG. 1A-2 is a schematic rear perspective view of the height milling device applied to the machining apparatus according to the present disclosure.

FIG. 1A-3 is a schematic perspective view of a transport device of the machining apparatus of FIG. 1A-1.

FIG. 1B is a partially-enlarged perspective view of position B of FIG. 1A-3.

FIG. 1C-1 is a schematic top perspective view of a target object to be machined by the machining apparatus of FIG. 1A-1.

FIG. 1C-2 is a schematic bottom perspective view of FIG. 1C-1.

FIG. 1C-3 is a schematic side plan view of FIG. 1C-1.

FIG. 1D is a schematic side plan view of the target object that is already machined by the machining apparatus of FIG. 1A-1.

FIG. 2A-1 is a schematic perspective view of a height milling device according to the present disclosure.

FIG. 2A-2 is a partially exploded perspective view of FIG. 2A-1.

FIG. 2B is a schematic top plan view according to another embodiment of FIG. 2A-1.

FIG. 2C is a schematic left plan view of FIG. 2B.

FIG. 2D is a schematic front plan view of FIG. 2B.

### DETAILED DESCRIPTION

The following illustrative embodiments are provided to illustrate the present disclosure, these and other advantages and effects can be apparent to those in the art after reading this specification.

It should be noted that all the drawings are not intended to limit the present disclosure. Various modifications and variations can be made without departing from the spirit of the present disclosure. Further, terms such as “up,” “down,” “front,” “rear,” “left,” “right,” “a,” etc., are merely for illustrative purposes and should not be construed to limit the scope of the present disclosure.

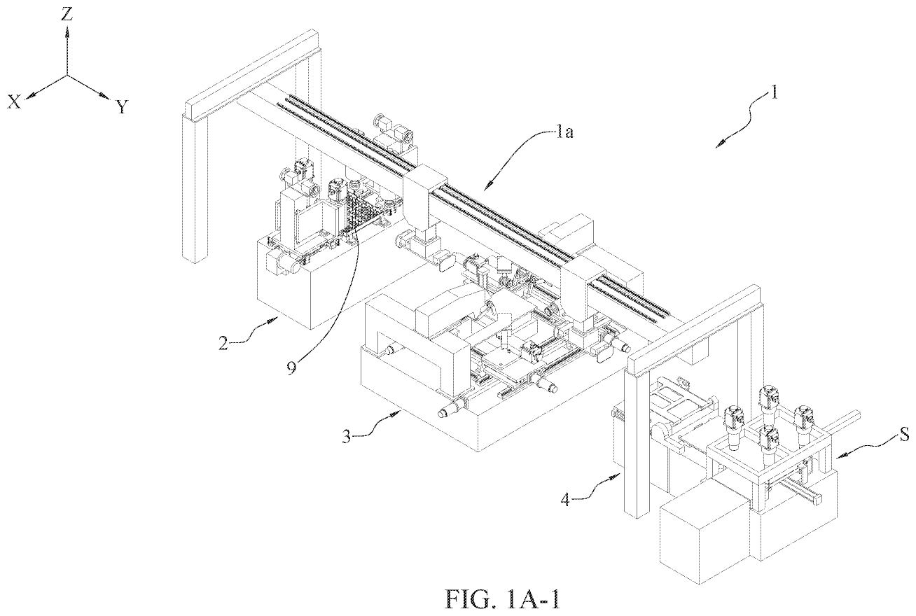

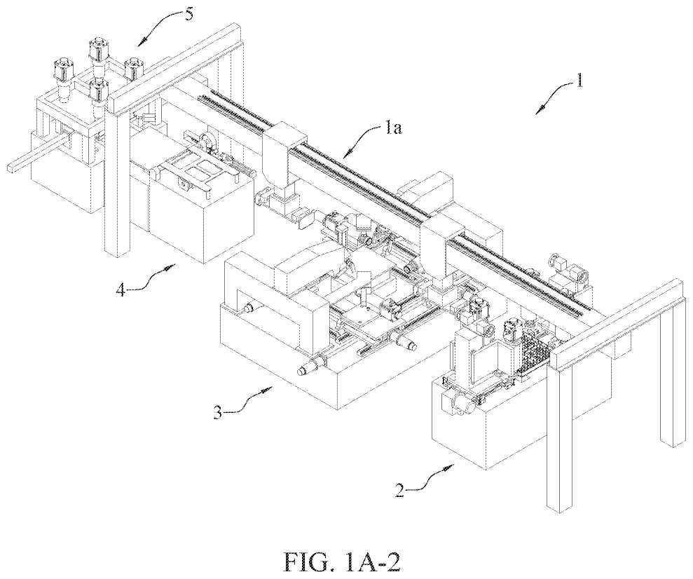

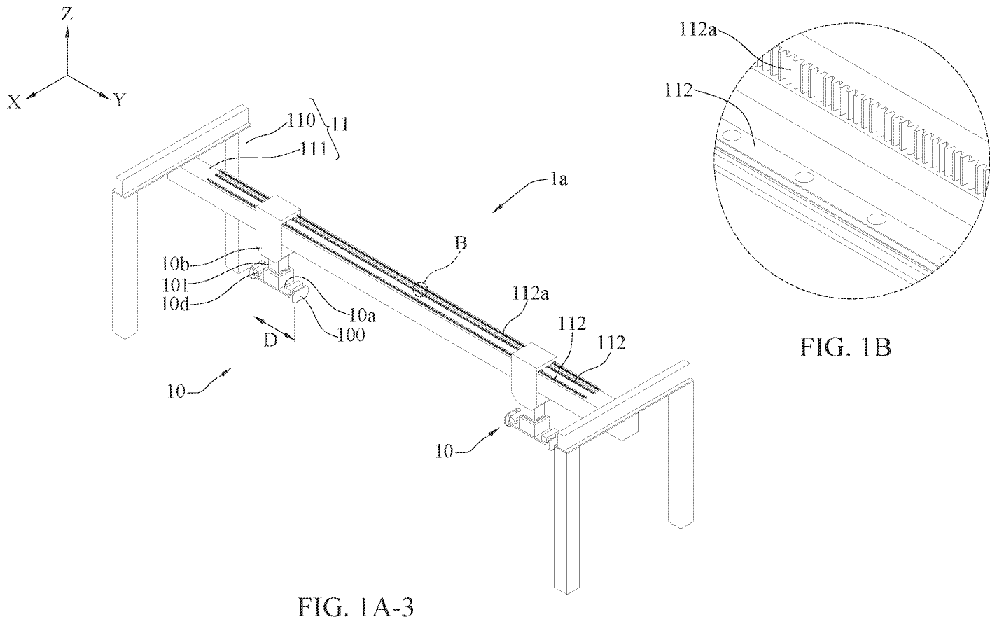

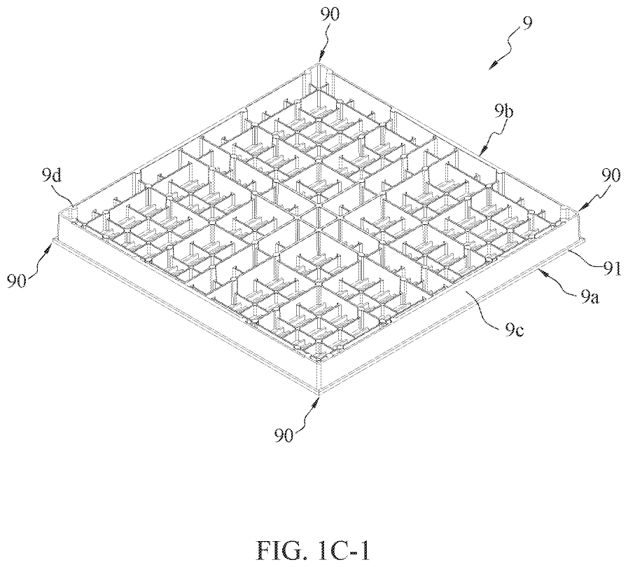

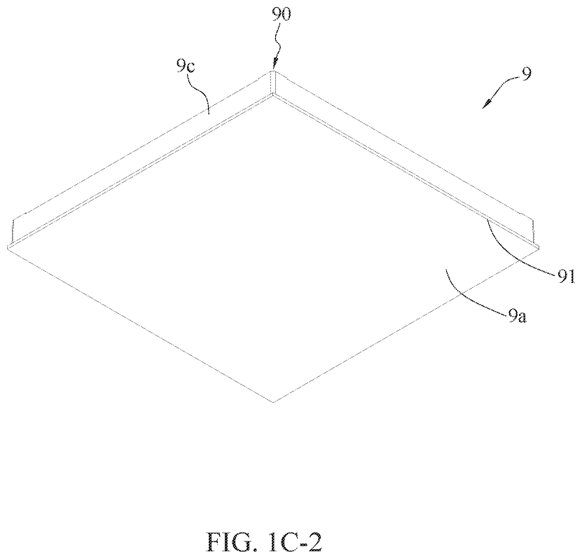

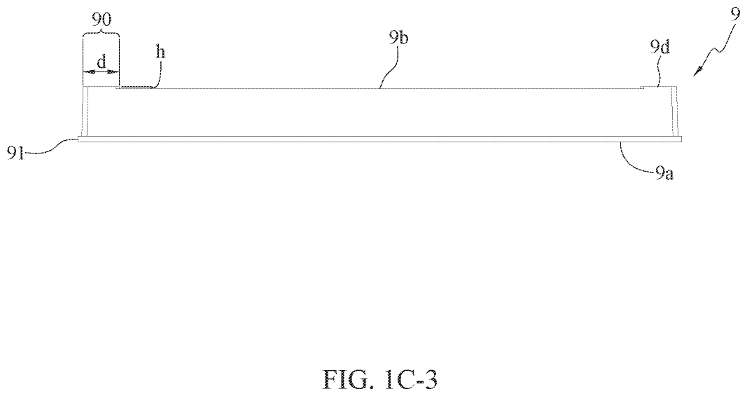

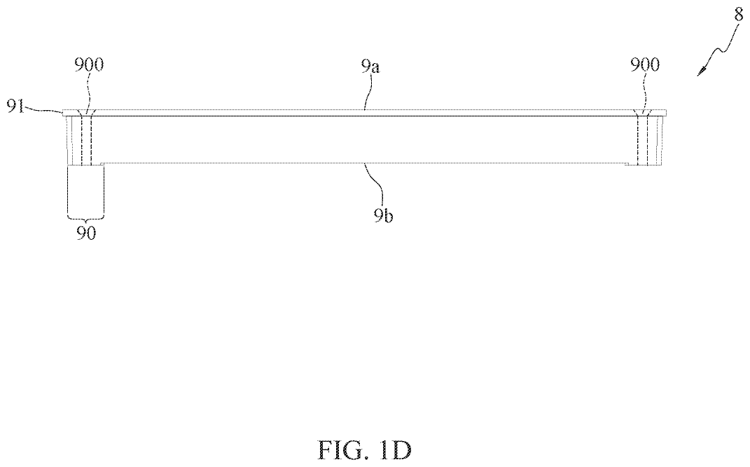

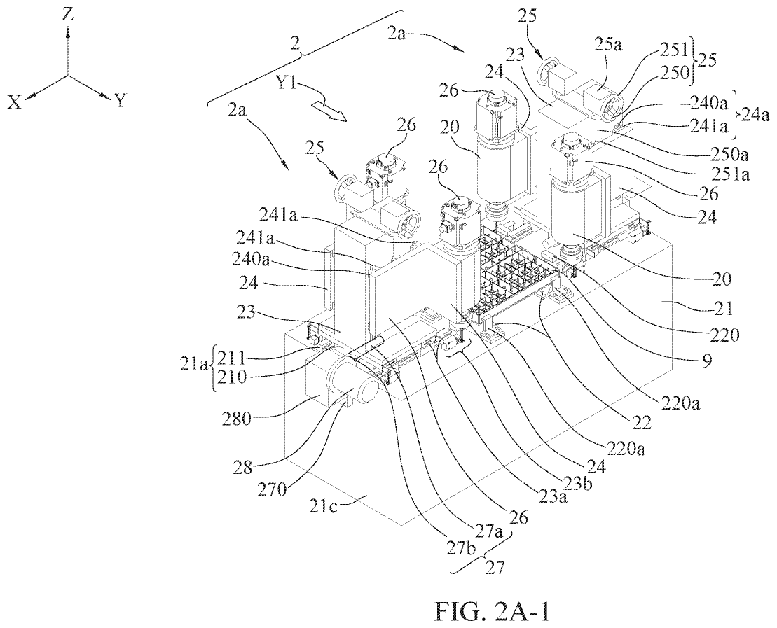

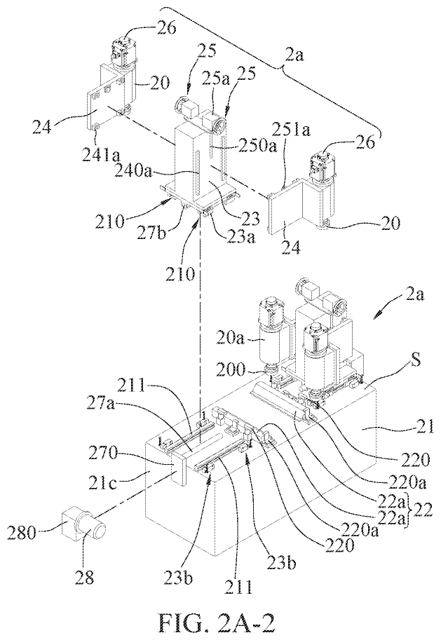

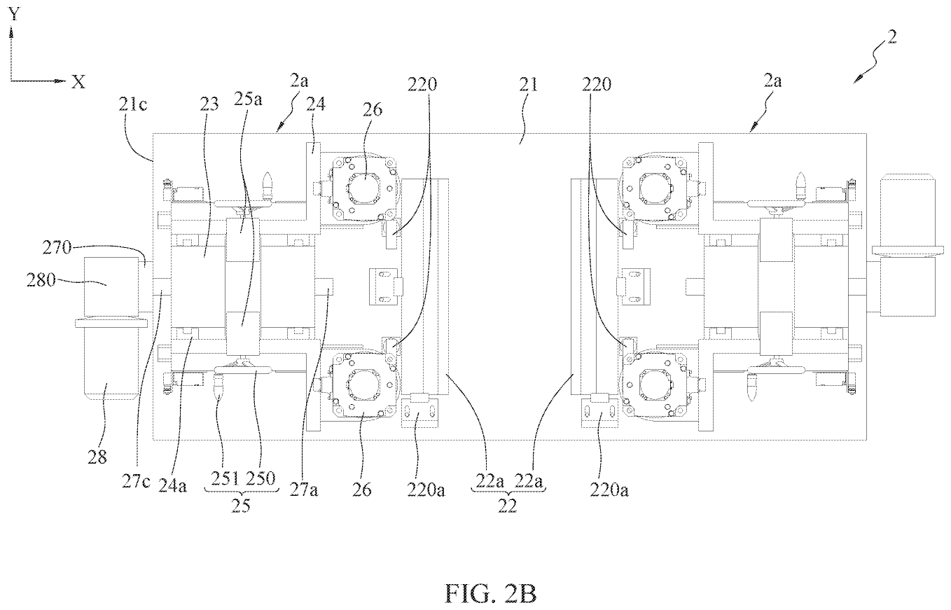

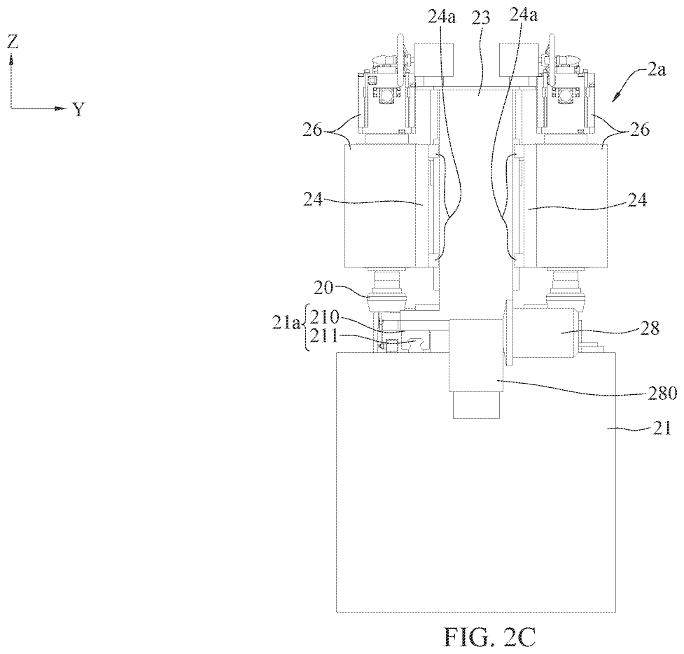

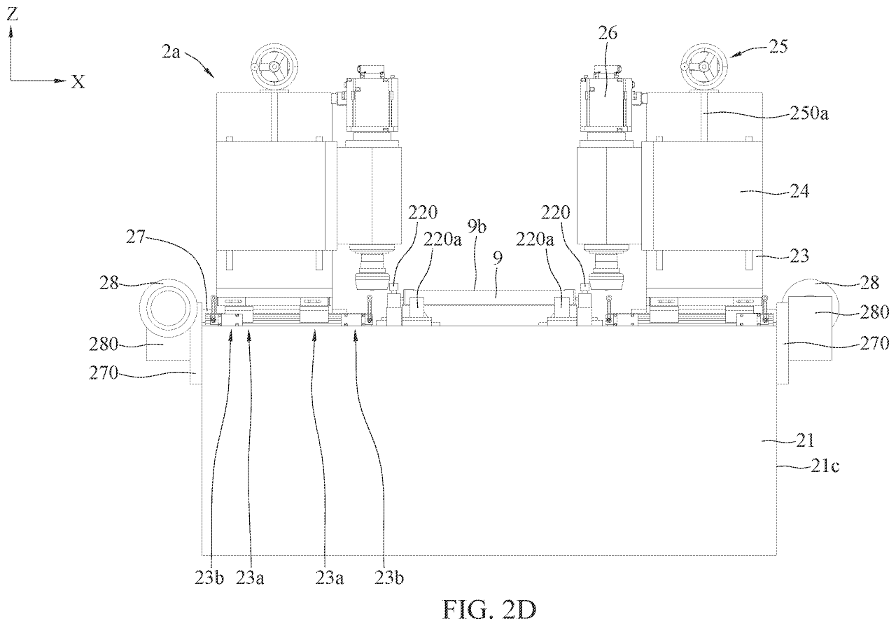

FIGS. 1A-1 and 1A-2 are schematic perspective views of a height milling device 2 applied to a machining apparatus 1 according to the present disclosure. Referring to FIGS. 1A-1 and 1A-2, the machining apparatus 1 has a transport device 1a, a height milling device 2, an edge milling device 3, a flipping device 4 and a hole forming device 5.

In an embodiment, for the machining apparatus 1 and for purpose of illustration, the direction of the production line is defined as a left or right direction (e.g., an arrow direction Y), a direction perpendicular to the production line is defined as a front or rear direction (e.g., an arrow direction X), and the height direction along the machining apparatus 1 is defined as a top or bottom direction (e.g., an arrow direction Z). However, the aforementioned orientations merely illustrate the arrangement of the embodiment, and the present disclosure is not limited thereto.

The transport device 1a is used to transport (e.g., gripping) a target object 9 to a machining position of the production line. To facilitate placing of the target object 9 on the height milling device 2, the edge milling device 3, the flipping device 4 and/or the hole forming device 5, the transport device 1a is disposed over the height milling device 2, the edge milling device 3, the flipping device 4 and the hole forming device 5.

In an embodiment, referring to FIG. 1A-3, the transport device 1a has at least a picking and placing component 10 for picking and placing the target object 9, and a support component 11 for displaceably arranging the picking and placing component 10 and allowing the picking and placing component 10 to displace so as to move the target object 9. For example, the support component 11 has a frame structure, which has two groups of door-shaped rod frames 110 (e.g., opposite to each other) vertically disposed on a base surface (e.g., floor) and a beam 111 disposed across the rod frames 110. The beam 111 is positioned over the height milling device 2, the edge milling device 3 and the flipping device 4 to serve as a displacement path of the picking and placing component 10. It should be understood that the support component 11 can be of various types and not limited to the above.

Further, the picking and placing component 10 has a gripping portion 10a with a holding member 100 and a carrying portion 10b for arranging the gripping portion 10a. For example, the width D of the holding member 100 of the gripping portion 10a can be adjusted according to the requirement so as to grip the target object 9 having a different width. A hydraulic or pneumatic cylinder (serving as a power source 10d) can be used to control the width of the two gripping portions 10a so as to grip or loosen the target object 9. The carrying portion 10b is a movable frame, which is vertically arranged on the beam 111 (or a position limiter 112) and pivotally connected to a gear (not shown). The gear (not shown) is engaged with a rack 112a (as shown in FIG. 1B). A driving force causes the gear to move linearly on the rack 112a such that the picking and placing component 10 can move linearly back and forth in the arrow direction Y with a sliding base (e.g., the carrying portion 10b) and the sliding rail component (e.g., the position limiter 112 and the rack 112a and gear on the position limiter 112). The plurality of power sources 10d (e.g., the pneumatic or hydraulic cylinder of FIG. 1A-3) drive the gripping portion 10a to bring the holding member 100 to extend outward or retract inward (in the arrow direction Y), thus producing a loosening or holding action. Further, a retractable structure 101 connected to the gripping portion 10a is disposed on the bottom of the carrying portion 10b so as to lift or descend the gripping portion 10a. A motor (not shown) can be disposed over the carrying portion 10b so as to drive the carrying portion 10b to displace, thereby driving the gear to move linearly on the rack 112a.

Furthermore, the number of the picking and placing component 10 can be set according to needs. For example, the picking and placing components 10 are respectively arranged corresponding to machining positions of the height milling device 2, the edge milling device 3 and the flipping device 4 (as such, at least two picking and placing components 10 are arranged). For instance, one picking and placing component 10 is arranged between the height milling device 2 and the edge milling device 3, and the other picking and placing component 10 is arranged between the edge milling device 3 and the flipping device 4. If needed, a plurality of picking and placing components 10 can be added between the rod frames 110 and the height milling device 2 to server as intermediate transferring components of the target object 9. As such, the target object 9 can be continuously picked and placed at each machining position so as to complete machining of the entire production line.

In addition, referring to FIGS. 1C-1, 1C-2 and 1C-3, the target object 9 is an elevated floor, which has a first surface 9a (e.g., a floor surface), a second surface 9b (e.g., a bottom end) opposite to the first surface 9a, and a side surface 9c adjacent to and connecting the first surface 9a and the second surface 9b. For example, the target object 9 is a substantially rectangular body (e.g., a square plate), the bottom of the target object 9 (e.g., the second surface 9b, which is the bottom of the elevated floor) has a honeycomb shape, and four corners of the second surface 9b of the target object 9 have four foot bases 90. Referring to FIG. 1D, holes 900 can be formed in the four foot bases 90 so as to fasten the four foot bases 90 on support legs by using screws (the support legs are used by the elevated floor). End surfaces 9d of the foot bases 90 slightly protrude from the second surface 9b of the target object 9 (with a height difference h, as shown in FIG. 1C-3), and a flange 91 is formed at an edge of the first surface 9a and protrudes from the side surface 9c. The flange 91 is the four edges of the elevated floor to be machined by the edge milling device 3. Since the target object 9 of the present embodiment is an elevated floor, it is referred to as elevated floor hereinafter.

FIGS. 2A-1 to 2D are schematic views of the height milling device 2 according to the present disclosure. In an embodiment, the height milling device 2 is disposed at the earliest machining stage of the entire production line and actuates in cooperation with the transport device 1a to machine the end surfaces 9d of the foot bases 90. For example, the height milling device 2 is used to remove the burrs on the end surfaces 9d of the four foot bases 90 of the elevated floor so as to machine the elevated floor to a required height.

Referring to FIGS. 2A-1 to 2D, the height milling device 2 has a height milling component 2a for machining the end surfaces 9d of the four foot bases 90 of the target object 9. The height milling component 2a has at least a milling tool 20, at least a servo motor 26 (e.g., the servo motor 26 may be used as a motor), at least a support structure 23, a carrying structure 24 disposed on two sides of the support structure 23 for arranging the milling tool 20, and an adjustment structure 25. The target object 9 is fastened on a fastening device 2b, which has a base platform 21 and a positioning structure 22 disposed on and in parallel to the base platform 21. At least a height milling component 2a is disposed on the base platform 21 and positioned around the positioning structure 22. The height milling component 2a corresponds to the positioning structure 22 and rises and descends relative to the positioning structure 22 so as to adjust the height milling amount of the target object 9 (elevated floor). After the height milling amount is set, the height milling component 2a moves horizontally to machine the foot bases 90 of the target object 9. After the height milling machining of the target object 9 is completed, the transport device 1 moves the target object 9 away from the positioning structure 22.

The base platform 21 is a machine tool working platform, which is a substantially rectangular body and has a working surface S of a rectangular planar shape.

In an embodiment, the base platform 21 can be provided with electromechanical components such as motors, wires, or other related units that are required by the production line.

The positioning structure 22 is disposed in the middle of the working surface S of the base platform 21 so as to position and carry the target object 9 as shown in FIG. 2A-1.

In an embodiment, the positioning structure 22 is a frame body, such as two straight bar-shaped frame bodies 22a or square-shaped frame bodies arranged in parallel, to one another, and the height milling component 2a is disposed at opposite sides (e.g., front and rear sides) of the frame bodies 22a. The fastening device 2b further has at least a fastening portion 220 (e.g., swing clamp cylinder) disposed outside of the opposite sides of the positioning structure 22. In operation, the fastening portion 220 of the present embodiment (e.g., swing clamp cylinder) fastens the elevated floor on the base platform 21. At least a swing clamp cylinder is disposed at one side of the frame bodies 22a so as to restrict the displacement of the elevated floor and prevent deviation of the elevated floor from the positioning structure 22 during a milling operation.

Moreover, the fastening device 2b further has at least a stop portion 220a disposed at an outer side of the positioning structure 22 (e.g., perpendicular to the side of the positioning structure 22 with the swing clamp cylinder) for blocking the side surface 9c of the elevated floor, thus facilitating an operator to push the target object 9 (e.g., in the arrow direction Y1) onto the positioning structure 22. Alternatively, the target object 9 to be machined can be gripped by the transport device 1 from a feeding position (not shown) and placed at a machining position on the positioning structure 22.

The height milling component 2a is symmetrically disposed at the two opposite sides (e.g., front and rear sides) of the positioning structure 22. Referring to FIGS. 2A-1 and 2A-2, the height milling component 2a has at least a milling tool 20, at least a support structure 23 displaceably disposed on the base platform 21, and a carrying structure 24 disposed on two sides of the support structure 23 for arranging the milling tool 20. The displacement of the support structure 23 relative to the base platform 21 causes the carrying structure 24 and the milling tool 20 thereon to move close to or away from the positioning structure 22.

In an embodiment, in the height milling device 2, two separate support structures 23 and four separate carrying structures 24 are provided to form two units each comprising one support structure 23 and two carrying structures 24. The two units are parallelly disposed at the two opposite sides of the positioning structure 22, and the two separate carrying structures 24 of each unit are fastened on the two opposite sides of the corresponding support structure 23 such that the four milling tools 20 on the carrying structures 24 are simultaneously driven by the same power unit 28. Further, two power units 28 can simultaneously drive the support structures 23 so as to rapidly and simultaneously machine the four foot bases 90 of the target object 9 to the required height. A milling cutter 200 is disposed at the bottom of a body 20a of the milling tool 20. The milling cutter 200 can be of various types and the present disclosure is not limited thereto.

Further, the support structure 23 is a seat body, which is displaceably disposed on the working surface S of the base platform 21. A driving structure 27 is disposed on the working surface S of the base platform 21 for driving the support structure 23 to displace, and a power unit 28 is disposed on the working surface S of the base platform 21 for actuating the driving structure 27. For example, the power unit 28 is a motor, which is fastened on a side surface 21c of the base platform 21 via a reducer 280. The driving structure 27 has a ball screw 27a, a bearing (not shown) and a nut 27b. The bearing is disposed on a bearing base 270 (which is fastened on the side surface 21c of the base platform 21), one end of the ball screw 27a is engaged with the bearing of the bearing base 270, and the nut 27b is fastened on the bottom of the support structure 23. When the power unit 28 drives the reducer 280 to rotate the ball screw 27a, the ball screw 27a can drive the support structure 23 on the nut 27b to move linearly back and forth for a certain distance. The distance is greater than or equal to the width d of the foot bases 90 (as shown in FIG. 1C-3). As such, the ball screw 27a drives the support structure 23 to move close to or away from the positioning structure 22. Furthermore, at least a baffle 23a can be disposed on a side of the support structure 23, and at least a limiter 23b can be disposed on the base platform 21. The machining stroke of the milling tool 20 can be controlled by the position where the baffle 23a contacts the limiter 23b. In order to provide a combination 21a of a guiding rail and a sliding base, a plurality of sliding blocks 210 are disposed on the bottom of the support structure 23 to serve as the sliding base, and a plurality of sliding rails 211 correspondingly engaged to the sliding blocks 210 are disposed on the base platform 21 to serve as the guiding rail, thus allowing the sliding blocks 210 to move linearly along the sliding rails 211. As such, the driving structure 27 can simultaneously drive the support structure 23, the two carrying structures 24 on the support structure 23, and the servo motors 26 and the milling tools 20 fastened on the carrying structures 24 to move a certain distance (greater than or equal to the width d of the foot bases 90) relative to the base platform 21 so as to machine the end surfaces 9d of the four foot bases 90 and achieve the required height of the elevated floor. Alternatively, a hydraulic or pneumatic cylinder can be used to drive the support structure 23.

Further, the carrying structure 24 is an L-shaped frame body symmetrically disposed on the left and right sides of the support structure 23. The servo motor 26 and the milling tool 20 are disposed on the same side of the carrying structure 24, where the milling tool 20 is disposed on the side of the carrying structure 24 facing the positioning structure 22, and the milling tool 20 is actuated by the servo motor 26. For example, the servo motor 26 may be used as a motor or is a motor, which actuates the milling tool 20 to rotate so as to machine the foot bases 90 of the target object 9 to the required height.

Furthermore, the carrying structure 24 can rise and descend relative to the support structure 23 (move up and down in the arrow direction Z). The adjustment structure 25 is disposed on the support structure 23. The adjustment structure 25 has a combination of a rotating rod 250 and a rotating disc 251. The rotating rod 250 can be manually operated so as to rotate the rotating disc 251. As such, the adjustment structure 25 rotates a reducer 25a so as to drive a screw 250a to rotate, which further drives a nut 251a to move up and down. Since the nut 251a is fastened on the carrying structure 24, the screw 250a can drive the carrying structure 24 to rise and descend (e.g., in the arrow direction Z), thereby moving the milling tool 20 to the required height position. For example, the carrying structure 24 can be disposed on the support structure 23 via a guiding structure 24a. The guiding structure 24a has a sliding rail 240a and a sliding base 241a engaged with the sliding rail 240a. The sliding rail 240a is fastened on two opposite surfaces of the support structure 23, and the sliding base 241a is fastened on the carrying structure 24. When the rotating rod 250 rotates the rotating disc 251, the milling tool 20 on the carrying structure 24 is moved linearly up and down (e.g., in the arrow direction Z) along the sliding rail 241a. Further, the milling tool 20 can be adjusted to the height required to machine the foot bases 90 according to the scale on a numerical instrument of the adjustment structure 25. For instance, the numerical instrument (not shown) can be disposed on the rotating disc 251 of the adjustment structure 25 to clearly control the height position of the carrying structure 24, thus allowing the milling tool 20 to mill the four foot bases 90 of the target object 9 to the required height, for example, from a height of 56 mm before the milling machining to a height of 55 mm after the milling machining.

When the machining apparatus 1 is used on the production line, a single target object 9 is transported to the height milling device 2 via one of the picking and placing components 10 of the transport device 1a so as for the height milling device 2 to perform a height milling machining (i.e., milling burrs) on the four foot bases 90 of the target object 9. After the height milling machining is completed, the target object 9 is transported from the height milling device 2 to the edge milling device 3 via another picking and placing component 10 of the transport device 1a so as for the edge milling device 3 to mill burrs on the flange 91 of the four side surfaces 9c of the target object 9.

Since the early milling operation is performed on the bottom of the elevated floor (the second surface 9b of the target object 9) and a later drilling operation is to be performed on the top surface of the elevated floor (the first surface 9a of the target object 9), it is necessary to flip the elevated floor before the drilling operation. Therefore, the target object 9 is transported from the edge milling device 3 to the flipping device 4 via another picking and placing component 10 of the transport device 1a so as to be flipped 180 degrees and then moved to the hole forming device 5.

Finally, the hole forming device 5 drills counterbored holes in the foot bases 90 of the target object 9 (e.g., holes 900 of FIG. 1D). After the drilling operation, the machined target object 8 (as shown in FIG. 1D) is discharged, thus completing the machining of the elevated floor.

According to the height milling device 2 and the height milling component 2a thereof, the servo motor 26 actuates the milling tool 20 (e.g., the servo motor 26 may be used as a motor). The servo motor 26 is linearly integrated with the milling tool 20 so as to reduce the volume and directly drive the milling tool 20 to rotate. Therefore, the present disclosure is characterized in that the servo motor 26 directly drives the milling tool 20 to rotate, which not only reduces the volume of the height milling device 2, but also improves the machining precision and speed via digital control of rotation of the servo motor 26. The conventional motor driving cannot achieve such an efficiency.

By performing a height milling machining on the foot bases 90 of the elevated floor via the height milling component 2a, the present disclosure speeds up the production, improves the production efficiency and reduces the labor cost.

The above-described descriptions of the detailed embodiments are to illustrate the implementation according to the present disclosure, and it is not to limit the scope of the present disclosure. Accordingly, all modifications and variations completed by those with ordinary skill in the art should fall within the scope of present disclosure defined by the appended claims.

What is claimed is:

1. A height milling component, comprising:
at least one milling tool;
at least one motor integrated with the milling tool in a linear manner for directly driving the milling tool;
at least one support structure having sliding rails disposed on surfaces of two opposite sides thereof;
at least one carrying structure symmetrically disposed on left and right sides of the support structure, wherein the motor and the milling tool are disposed on one side of the carrying structure and a sliding base is disposed on another side of the carrying structure; and
at least one adjustment structure for driving the milling tool on the carrying structure to move linearly up and down along the sliding rails to reach a height required to machine foot bases.

2. The height milling component of claim 1, wherein the carrying structure is an L-shaped frame body symmetrically disposed on the left and right sides of the support structure, and the motor and the milling tool are disposed on said one side of the carrying structure in a manner that the milling tool on the carrying structure moves linearly up and down along the sliding rails.

3. A height milling device, comprising:
the height milling component of claim 1;
a base platform having a working surface;
a positioning structure disposed on and in parallel to the working surface for carrying a target object and limiting displacement of the target object, wherein the target object has opposite first and second surfaces, a side surface adjacent to and connecting the first and second surfaces, and a flange protruding from the side surface, and wherein four corners of the second surface have four foot bases;
a fastening portion disposed at two opposite sides of the positioning structure for fastening the target object on the positioning structure; and
a driving structure for driving the support structure to displace and drive the height milling component to move linearly to perform a height milling machining on the target object.

4. The height milling device of claim 3, wherein the height milling component is displaceably disposed on the working surface of the base platform and arranged at the two opposite sides of the positioning structure to perform the height milling machining on the target object and machine end surfaces of the foot bases of the target object, wherein the at least one motor and the milling tool are disposed on the support structure of the base platform via the carrying structure, wherein the motor and the milling tool are disposed on the same side of the carrying structure, and wherein the positioning structure has a stop portion disposed on an outer side thereof for blocking the side surface of the target object.

5. The height milling device of claim 3, wherein the driving structure comprises a ball screw, a bearing engaged with the ball screw and disposed on a bearing base fastened on the base platform, and a nut engaged with the ball screw and fastened on a bottom of the support structure.

6. The height milling device of claim 5, further comprising a power unit fixedly disposed on the base platform via a reducer and used for driving the reducer to rotate the ball screw.

7. The height milling device of claim 3, further comprising a plurality of sliding blocks disposed on a bottom of the support structure and a plurality of sliding rails disposed on the base platform and correspondingly engaged with the sliding blocks to enable the sliding blocks to move linearly along the sliding rails, thereby causing the driving structure to simultaneously drive the support structure, the two carrying structures on the support structure, and the motor and the milling tool fastened on the carrying structure to displace a certain distance relative to the base platform.

8. The height milling device of claim 3, further comprising a guiding structure having a sliding rail fastened on the support structure and a sliding base fastened on the carrying structure and engaged with the sliding rail to enable the carrying structure to be disposed on the support structure via the guiding structure, thereby driving the carrying structure and the milling tool thereon to rise and descend relative to the support structure when the adjustment structure actuates.

9. The height milling device of claim 8, wherein the adjustment structure comprises a rotating rod and a rotating disc rotated by the rotating rod, and the adjustment structure rotates a reducer to drive a screw to rotate, thereby driving a nut fastened on the carrying structure to move up and down, driving the carrying structure to rise and descend, and moving the milling tool to a required height position.

10. The height milling device of claim 3, wherein the support structure has a baffle disposed thereon and the base platform has a limiter abutting against the baffle for controlling a position of the baffle, thereby controlling a displacement of the support structure.

11. The height milling device of claim 3, wherein the two separate support structures and the four separate carrying structures are provided to form two units each comprising the one support structure and the two carrying structures, the two units are parallelly disposed at the two opposite sides of the positioning structure, respectively, and the two separate carrying structures of each unit are fastened on the two opposite sides of the corresponding support structure, respectively, such that the milling tools on the carrying structures are simultaneously driven by the same power unit.
